(19) United States
(12) Patent Application Publication
(10) Pub. No.: US 2025/0365036 A1
(43) Pub. Date: Nov. 27, 2025

(54) NOISE REMOVING APPARATUS, NOISE REMOVING METHOD, AND NON-TRANSITORY RECORDING MEDIUM

(71) Applicant: NEC Corporation, Tokyo (JP)

(72) Inventor: Tsubasa ASAI, Tokyo (JP)

(73) Assignee: NEC Corporation, Tokyo (JP)

(21) Appl. No.: 19/204,726

(22) Filed: May 12, 2025

(30) Foreign Application Priority Data
May 22, 2024 (JP) 2024-083365

(51) Int. Cl. H04B 3/32; H04B 3/487

(52) U.S. Cl. CPC H04B 3/32; H04B 3/487

(57) ABSTRACT

A noise removing method executed by a computer is disclosed. In the method, a computer executes determining whether a beat waveform generation condition, which is a condition for beat waveform generation by first and second signals, is satisfied based on frequencies of the first and second signals received via adjacent communication cables. The computer executes correcting the frequency of at least one of the first and second signals when it is determined that the beat waveform generation condition is satisfied. The computer executes transmitting at least the signal of which the frequency has been corrected.

### INCORPORATION BY REFERENCE

This application is based upon and claims the benefit of priority from Japanese patent application No. 2024-083365, filed on May 22, 2024, the disclosure of which is incorporated herein in its entirety by reference.

### TECHNICAL FIELD

The present disclosure relates to a noise removing apparatus, a noise removing method, and a non-transitory recording medium for removing noise of a signal received via an adjacent communication cable.

### BACKGROUND ART

In the related art, various techniques for removing noise generated in received signals have been proposed. As an example of such a technique, a noise detection apparatus disclosed in Patent Literature 1 determines whether there is noise superimposed on a received signal based on a difference between a characteristic of noise caused in a switching operation in a switching amplifier that amplifies an amplitude-adjusted audio signal and a characteristic of the received signal.

[Patent Literature 1] Japanese Unexamined Patent Application Publication No. 2018-125586

### SUMMARY

However, since the noise detection apparatus disclosed in Patent Literature 1 determines whether there is noise caused in a switching operation in a switching amplifier that amplifies an amplitude-adjusted audio signal, it is not possible to detect beat noise generated when a plurality of signals is simultaneously received via adjacent communication cables. Therefore, the noise detection apparatus disclosed in Patent Literature 1 has a problem that it is not possible to curb generation of beat noise in a signal received via an adjacent communication cable.

In view of the above-described problems, an example object of the present disclosure is to provide a noise removing apparatus, a noise removing method, and a noise removing program capable of curbing generation of beat noise in a signal received via an adjacent communication cable.

A noise removing apparatus according to a first example aspect of the present disclosure includes:
a beat waveform generation condition determination unit that determines whether a beat waveform generation condition, which is a condition for beat waveform generation by first and second signals, is satisfied based on frequencies of the first and second signals received via adjacent communication cables;
a correction unit that corrects the frequency of at least one of the first and second signals when the beat waveform generation condition determination unit determines that the beat waveform generation condition is satisfied; and
a transmission unit that transmits at least the signal of which the frequency has been corrected by the correction unit.

A noise removing method according to a second example aspect of the present disclosure causes a computer to execute:
determining whether a beat waveform generation condition, which is a condition for beat waveform generation by first and second signals, is satisfied based on frequencies of the first and second signals received via adjacent communication cables;
correcting the frequency of at least one of the first and second signals when it is determined that the beat waveform generation condition is satisfied; and
transmitting at least the signal of which the frequency has been corrected.

A non-transitory recording medium storing a noise removing program according to a third example aspect of the present disclosure is provided. The program causes a computer to execute:
determining whether a beat waveform generation condition, which is a condition for beat waveform generation by first and second signals, is satisfied based on frequencies of the first and second signals received via adjacent communication cables;
correcting the frequency of at least one of the first and second signals when it is determined that the beat waveform generation condition is satisfied; and
transmitting at least the signal of which the frequency has been corrected.

According to the present disclosure, it is possible to provide a noise removing apparatus, a noise removing method, and a non-transitory recording medium capable of curbing generation of beat noise in a signal received via an adjacent communication cable.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a hardware configuration of a noise removing apparatus according to the present disclosure;

FIG. 2 is a block diagram illustrating functions of the noise removing apparatus according to the present disclosure;

FIG. 3 is a flowchart illustrating an example of processing executed by the noise removing apparatus according to the present disclosure;

FIG. 4 is a flowchart illustrating another example of processing executed by the noise removing apparatus according to the present disclosure; and

FIG. 5 is a diagram illustrating main components included in the noise removing apparatus according to the present disclosure.

### EMBODIMENTS

Hereinafter, example embodiments will be described with reference to the drawings. FIG. 1 is a diagram illustrating a hardware configuration of a noise removing apparatus 1 according to the present disclosure. The noise removing apparatus 1 is an apparatus that removes noise of a signal received from a detection apparatus and transmits the signal. The noise removing apparatus 1 is connected to the detection apparatus installed at a remote location via a plurality of communication cables such as a submarine cable. Specific examples of the detection apparatus include a sensor that executes submarine observation.

The noise removing apparatus 1 includes an arithmetic device 10, reception units 11 and 21, storage devices 12 and 22, and transmission units 13 and 23. The arithmetic device 10 is a device that executes overall control of processing executed by the noise removing apparatus 1. Specific examples of the arithmetic device 10 include processors such as a central processing unit (CPU) and a micro processing unit (MPU). In addition, an integrated circuit such as a field-programmable gate array (FPGA) or an application specific integrated circuit (ASIC) may be adopted as the arithmetic device 10. The arithmetic device 10 corresponds to a computer.

The reception units 11 and 21 are interfaces that receive signals transmitted from an external apparatus such as a detection apparatus via adjacent individual communication cables. Individual communication cables are connected to the reception units 11 and 21. The reception units 11 and 21 can simultaneously receive signals via adjacent communication cables. When frequencies of two signals received substantially simultaneously are close to each other or when frequencies obtained by multiplying the frequencies of these signals are close to each other, beat noise due to crosstalk may occur. Hereinafter, of the two signals received by the reception units 11 and 21 of the noise removing apparatus 1, a signal having a higher frequency is referred to as a first signal and a signal having a lower frequency is referred to as a second signal.

The storage devices 12 and 22 are storage devices that store signals received by the reception units 11 and 21. The transmission units 13 and 23 are interfaces that transmit signals to apparatuses disposed downstream of the noise removing apparatus 1 via cables.

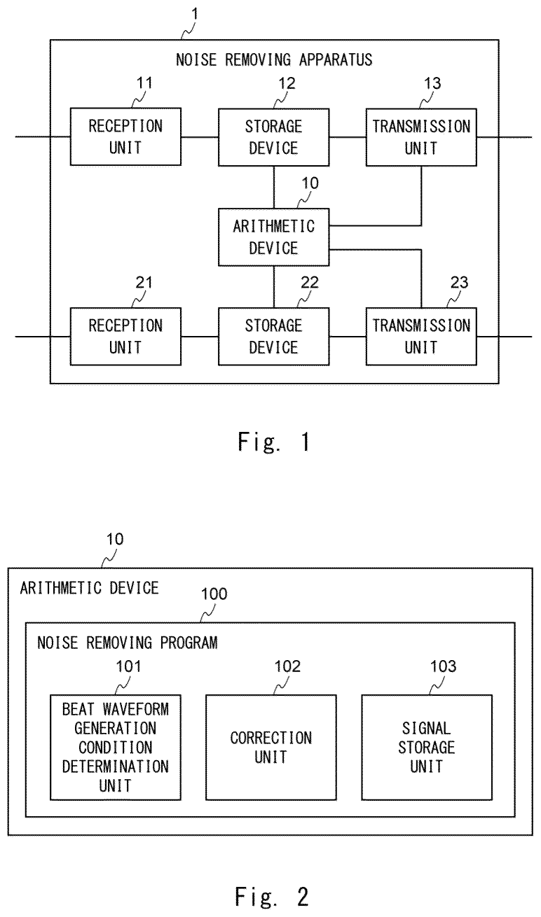

FIG. 2 is a block diagram illustrating an example of a noise removing program 100 executed by the arithmetic device 10. The noise removing program 100 includes a beat waveform generation condition determination unit 101, a correction unit 102, and a signal storage unit 103.

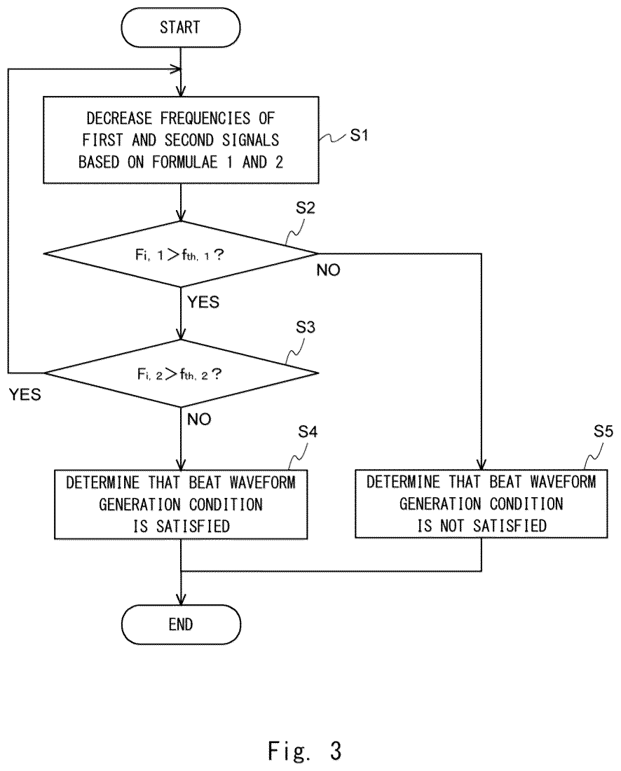

The beat waveform generation condition determination unit 101 is a program determining whether two signals satisfy a beat waveform generation condition. FIG. 3 is a diagram illustrating an example of processing executed by the beat waveform generation condition determination unit 101.

In step S1, the beat waveform generation condition determination unit 101 decreases frequencies of the first and second signals based on Formulae 1 and 2.

$$\begin{matrix}[ Math . 1 ] & \\ \begin{matrix}{F}_{i , 1} = {F}_{i - 1 , 2} \\ {F}_{i , 2} = {F}_{i - 1 , 1} - {n}_{i} \times {F}_{i - 1 , 2}\end{matrix} & ( 1 )\end{matrix}$$

Here, i is an integer of 1 or more and corresponds to a number of times a frequency is decreased by the beat waveform generation condition determination unit 101. F_{i,1} is a frequency of the first signal decreased i times. F_{i,2} is a frequency of the second signal decreased i times. F_{0,2} is a frequency of the second signal received by the reception unit 21, that is, a frequency f₂ of the second signal before the frequency is decreased. F_{0,1} is a frequency of the first signal received by the reception unit 11, that is, a frequency f₁ of the first signal before the frequency is decreased. nᵢ is an integer satisfying the condition of Formula 2.

$$\begin{matrix}[ Math . 2 ] & \\ {F}_{i - 1 , 2} > {F}_{i - 1 , 1} - {n}_{i} \times {F}_{i - 1 , 2} ≧ 0 & ( 2 )\end{matrix}$$

In step S2, the beat waveform generation condition determination unit 101 determines whether the frequency F_{i,1} of the first signal is larger than the corresponding threshold value f_{th,1}. When it is determined that the frequency F_{i,1} of the first signal is equal to or less than the threshold value f_{th, 1} (NO), in other words, when a ratio between the frequency F_{i,1} of the first signal and the frequency F_{i,2} of the second signal is not an integer ratio, the beat waveform generation condition determination unit 101 determines in step S5 that the beat waveform generation condition is not satisfied.

When it is determined that the frequency F_{i,1} of the first signal is larger than the threshold value f_{th, 1} (YES), the beat waveform generation condition determination unit 101 determines in step S3 whether the frequency F_{i,2} of the second signal is larger than a corresponding threshold value f_{th,2}. When it is determined that the frequency F_{i,2} of the second signal is larger than the threshold value f_{th,2} (YES), the process returns to step S1.

Conversely, when it is determined that the frequency F_{i,2} of the second signal is equal to or less than the threshold value f_{th, 2} (NO), the beat waveform generation condition determination unit 101 determines in step S4 that the beat waveform generation condition is satisfied. In this case, the ratio between the frequency F_{i,1} of the first signal and the frequency F_{i,2} of the second signal is an integer ratio.

When the ratio between the frequency f₁ of the received first signal and the frequency f₂ of the received second signal is α:β, an α-th harmonic of the first signal and a β-th harmonic of the second signal generate a beat, which causes generation of an unintended noise waveform. In general, lower order (when values of α and β are small) harmonics tend to be more influenced by a beat, whereas higher order (when the values of α and β are large) harmonics tend to be less influenced by a beat. Accordingly, for example, a condition of a ratio at which a significant influence occurs can be determined in advance such that a beat is ignored when the first and second signals are higher harmonics of an order of 100th or higher. For example, when the beats of the harmonics of the 100th order or higher are ignored, the threshold value f_{th,1} can be set to 1/100 (f₁/100) or the like of the frequency f₁ of the first signal received by the reception unit 11. The 100th order is an example, and the threshold value f_{th,1} can be set in accordance with a condition under which a significant influence occurs.

The ratio between the frequency f₁ of the received first signal and the frequency f₂ of the received second signal is likely to slightly deviate from a strict integer ratio. Therefore, the threshold value f_{th,2} can be a sufficiently smaller positive value than the threshold value f_{th, 1}, for example, 1/100 (f₁/100) of the threshold value f_{th,1,} that is, 1/1000 (f₁/1000) of the frequency f₁ of the received first signal, or the like. The threshold value f_{th, 2} is not necessarily set from the value of the threshold value f_{th,1}. The ratio of the threshold value f_{th, 1}:the threshold value f_{th,2} oes not need to be an integer ratio. It should be noted that these thresholds are each an independent numerical value.

The correction unit 102 is a program that corrects at least one of the frequencies of the two signals received by the reception units 11 and 21 of the noise removing apparatus 1. For example, the correction unit 102 can perform correction by adding or subtracting a predetermined frequency to or from one of the frequencies of the two signals.

The signal storage unit 103 is a program that stores the signal of which a frequency has been corrected by the correction unit 102 in the storage devices 12 and 22.

The arithmetic device 10 can output an execution result of the above-described process via the transmission units 13 and 23.

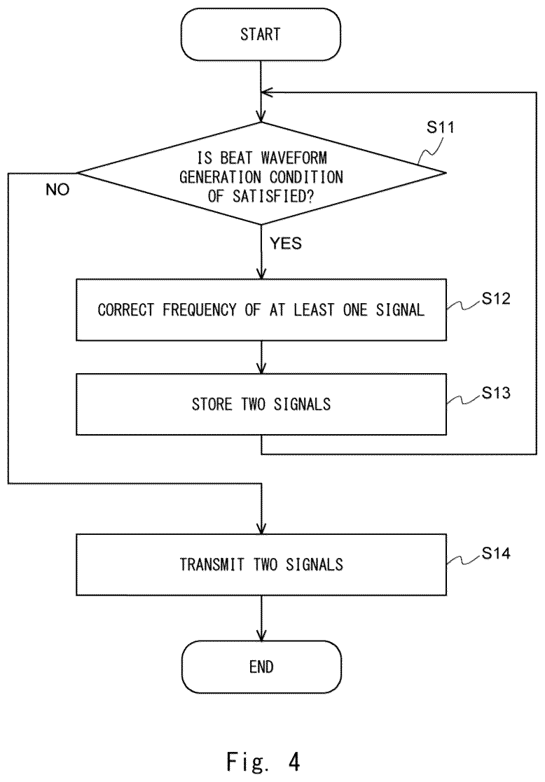

FIG. 4 is a flowchart illustrating an example of processing executed by the noise removing apparatus according to the present disclosure. Hereinafter, the noise removing apparatus 1 will be described as an example.

In step S11, the beat waveform generation condition determination unit 101 of the noise removing apparatus 1 determines whether the bit waveform generation condition is satisfied based on the frequencies of the two signals received by the reception units 11 and 21 of the noise removing apparatus 1. When it is determined that the beat waveform generation condition is not satisfied (NO), the process branches to step S14. In step S14, the transmission units 13 and 23 each transmit signals.

Conversely, when it is determined in step S11 that the beat waveform generation condition is satisfied (YES), the process branches to step S12. In step S12, the correction unit 102 corrects the frequency of at least one of the two signals received by the reception units 11 and 21.

In step S13, the signal storage unit 103 stores the two signals in the respective storage devices 12 and 22. At this time, when the two signals are both corrected, the signal storage unit 103 stores the corrected two signals in the storage devices 12 and 22. When only one of the signals is corrected, the signal storage unit 103 stores the corrected signal and the uncorrected signal in the storage devices 12 and 22.

When the process of step S13 is executed, the process returns to step S11. In step S11, the beat waveform generation condition determination unit 101 determines whether the beat waveform generation condition is satisfied using the signal of which the frequency has been corrected. More specifically, when the frequencies of the first and second signals are both corrected, the beat waveform generation condition determination unit 101 determines whether the beat waveform generation condition is satisfied based on the corrected frequencies of the first and second signals. When the frequency of the first signal is corrected and the frequency of the second signal is not corrected, the beat waveform generation condition determination unit 101 determines whether the beat waveform generation condition is satisfied based on the corrected frequency of the first signal and the uncorrected frequency of the second signal. When the frequency of the first signal is not corrected and the frequency of the second signal is corrected, the beat waveform generation condition determination unit 101 determines whether the beat waveform generation condition is satisfied based on the uncorrected frequency of the first signal and the corrected frequency of the second signal.

When it is determined in step S11 that the beat waveform generation condition is not satisfied after the signal is stored in step S13, the transmission units 13 and 23 transmit the latest signals stored in the storage devices 12 and 22 in step S14. Specifically, when the frequencies of the first and second signals are both corrected, the transmission units 13 and 23 transmit the first and second signals of which the frequencies are corrected, respectively. When the frequency of one of the first and second signals is corrected, the transmission units 13 and 23 transmit the signal of which the frequency has been corrected and the signal of which the frequency has not been corrected. More specifically, when the frequency of the first signal is corrected, the transmission unit 13 transmits the first signal of which the frequency has been corrected, and the transmission unit 23 transmits the second signal of which the frequency has not been corrected. Conversely, when the frequency of the second signal is corrected, the transmission unit 13 transmits the first signal of which the frequency has not been corrected, and the transmission unit 23 transmits the second signal of which the frequency has been corrected.

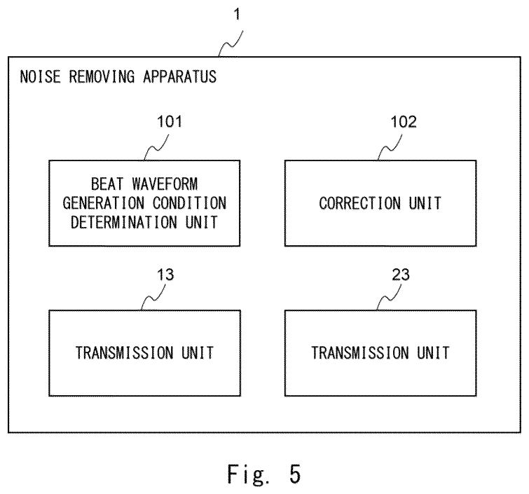

FIG. 5 is a diagram illustrating main components included in the noise removing apparatus 1 according to the present disclosure. The noise removing apparatus 1 includes a beat waveform generation condition determination unit 101, a correction unit 102, and the transmission units 13 and 23.

The beat waveform generation condition determination unit 101 determines whether a beat waveform generation condition, which is a condition for generating beat waveforms by the first and second signals, is satisfied based on the frequencies of the first and second signals received via the adjacent communication cable. When the beat waveform generation condition determination unit determines that the beat waveform generation condition is satisfied, the correction unit 102 corrects the frequency of at least one of the first and second signals. The transmission units 13 and 23 transmit at least the signal of which the frequency has been corrected by the correction unit 102.

By adopting this configuration, the noise removing apparatus 1 corrects the frequency of at least one of these signals when two signals are received at the same time via the adjacent communication cable and there is a possibility of beat noise occurring in the two signals. Then, the noise removing apparatus 1 transmits the signal of which the frequency has been corrected. As a result, it is possible to curb occurrence of the beat noise with respect to a signal to be transmitted in the transmission device downstream of the noise removing apparatus 1.

The beat waveform generation condition determination unit 101 determines whether the beat waveform generation condition is satisfied based on the frequency of the signal corrected by the correction unit 102. Then, when it is determined that the beat waveform generation condition is not satisfied based on the frequency of the signal corrected by the correction unit 102, the transmission units 13 and 23 transmit the signal of which the frequency has been corrected by the correction unit 102. As a result, in a transmission device downstream of the noise removing apparatus 1, it is possible to effectively curb occurrence of beat noise with respect to the signal to be transmitted.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as in the following Supplementary Notes, but are not limited to the following Supplementary Notes.

### (Supplementary Note 1)

A noise removing apparatus including:
a beat waveform generation condition determination unit that determines whether a beat waveform generation condition, which is a condition for beat waveform generation by first and second signals, is satisfied based on frequencies of the first and second signals received via adjacent communication cables;
a correction unit that corrects the frequency of at least one of the first and second signals when the beat waveform generation condition determination unit determines that the beat waveform generation condition is satisfied; and
a transmission unit that transmits at least the signal of which the frequency has been corrected by the correction unit.

### (Supplementary Note 2)

The noise removing apparatus according to Supplementary Note 1, wherein the beat waveform generation condition determination unit determines whether the beat waveform generation condition is satisfied based on the frequency of the signal corrected by the correction unit, and the transmission unit transmits the signal of which the frequency has been corrected by the correction unit when it is determined that the beat waveform generation condition is not satisfied based on the frequency of the signal corrected by the correction unit.

### (Supplementary Note 3)

The noise removing apparatus according to Supplementary Note 1 or 2, wherein
of the received signals, a signal having a higher frequency is the first signal, and a signal having a lower frequency is the second signal, and
the beat waveform generation condition determination unit decreases a frequency F_{i,1} of the first signal and a frequency F_{i,2} of the second signal based on Formula 1 and determines that the beat waveform generation condition is satisfied when the decreased frequency F_{i,1} of the first signal is greater than the corresponding predetermined threshold f_{th, 1} and the decreased frequency F_{i,2} of the second signal is equal to or less than each corresponding predetermined threshold f_{th, 2,}

$$\begin{matrix}[ Math . 1 ] & \\ \begin{matrix}{F}_{i , 1} = {F}_{i - 1 , 2} \\ {F}_{i , 2} = {F}_{i - 1 , 1} - {n}_{i} \times {F}_{i - 1 , 2}\end{matrix} & ( 1 )\end{matrix}$$

wherein i in Formula 1 is an integer representing a number of times the frequencies of the first and second signals are decreased, F_{i,1} represents the frequency of the first signal decreased i times,

F_{i,2} represents the frequency of the second signal decreased i times,

F_{0,2} represents the frequency of the second signal before the frequency is decreased,

F_{0,1} represents a frequency f₁ of the first signal before the frequency is decreased, and

nᵢ is an integer satisfying a condition of Formula 2,

$$\begin{matrix}[ Math . 2 ] & \\ {F}_{i - 1 , 2} > {F}_{i - 1 , 1} - {n}_{i} \times {F}_{i - 1 , 2} ≧ 0 & ( 2 )\end{matrix}$$

(Supplementary Note 4)

The noise removing apparatus according to Supplementary Note 1 or 2, wherein when it is determined that the beat waveform generation condition is satisfied, the correction unit corrects the frequency of at least one of the first and second signals by adding a predetermined frequency to the frequency of at least one of the first and second signals or subtracting the predetermined frequency from the frequency of the at least one signal.

### (Supplementary Note 5)

The noise removing apparatus according to Supplementary Note 1 or 2, wherein the transmission unit transmits the first and second signals of which the frequencies have been corrected when the frequencies of both the first and second signals are corrected by the correction unit.

### (Supplementary Note 6)

The noise removing apparatus according to Note 5, wherein
the transmission unit transmits the first signal of which the frequency has been corrected and the second signal of which the frequency has not been corrected when the frequency of the first signal is corrected by the correction unit, and
the transmission unit transmits the first signal of which the frequency has not been corrected and the second signal of which the frequency has been corrected when the frequency of the second signal is corrected by the correction unit.

### (Supplementary Note 7)

A noise removing method of causing a computer to execute:
determining whether a beat waveform generation condition, which is a condition for beat waveform generation by first and second signals, is satisfied based on frequencies of the first and second signals received via adjacent communication cables;
correcting the frequency of at least one of the first and second signals when it is determined that the beat waveform generation condition is satisfied; and
transmitting at least the signal of which the frequency has been corrected.

### (Supplementary Note 8)

The noise removing method according to Supplementary Note 7, wherein, of the received signals, a signal having a higher frequency is the first signal, and
a signal having a lower frequency is the second signal, and
the computer executes:
determining whether the beat waveform generation condition is satisfied based on the corrected frequency of the signal; and
transmitting the signal of which the frequency has been corrected when it is determined that the beat waveform generation condition is not satisfied based on the corrected frequency of the signal.

### (Supplementary Note 9)

The noise removing method according to Supplementary Note 7 or 8, wherein
the computer executes:
decreasing a frequency F_{i,1} of the first signal and a frequency F_{i,2} of the second signal based on Formula 1; and
determining that the beat waveform generation condition is satisfied when both the decreased frequency F_{i,1} of the first signal and the decreased frequency F_{i,2} of the second signal are equal to or less than each of corresponding predetermined thresholds,

$$\begin{matrix}[ Math . 1 ] & \\ \begin{matrix}{F}_{i , 1} = {F}_{i - 1 , 2} \\ {F}_{i , 2} = {F}_{i - 1 , 1} - {n}_{i} \times {F}_{i - 1 , 2}\end{matrix} & ( 1 )\end{matrix}$$

wherein i in Formula 1 is an integer representing a number of times the frequencies of the first and second signals are decreased,
F_{i,1} represents the frequency of the first signal decreased i times,
F_{i,2} represents the frequency of the second signal decreased i times,
F_{0,2} represents the frequency of the second signal before the frequency is decreased,
F_{0,1} represents a frequency f₁ of the first signal before the frequency is decreased, and
nᵢ is an integer satisfying a condition of Formula 2,

$$\begin{matrix}[ Math . 2 ] & \\ {F}_{i - 1 , 2} > {F}_{i - 1 , 1} - {n}_{i} \times {F}_{i - 1 , 2} ≧ 0 & ( 2 )\end{matrix}$$

### (Supplementary Note 10)

A non-transitory recording medium storing a noise removing program causing a computer to execute:
determining whether a beat waveform generation condition, which is a condition for beat waveform generation by first and second signals, is satisfied based on frequencies of the first and second signals received via adjacent communication cables;
correcting the frequency of at least one of the first and second signals when it is determined that the beat waveform generation condition is satisfied; and
transmitting at least the signal of which the frequency has been corrected.

Some or all of the elements described in Supplementary Notes 4 to 6 dependent on Supplementary Note 1 can also depend on Supplementary Note 9 in the same dependency relationship as Supplementary Notes 4 to 6. Some or all of the elements described in Supplementary Notes 2 to 6 dependent on

Supplementary Note 1 can also depend on Supplementary Note 10 in the same dependency relationship as Supplementary Notes 2 to 6. Some or all of the clements described in any Supplementary Note may be applied to various types of hardware, software, recording means for recording software, systems, and methods.

What is claimed is:

1. A noise removing method of causing a computer to execute:
determining whether a beat waveform generation condition, which is a condition for beat waveform generation by first and second signals, is satisfied based on frequencies of the first and second signals received via adjacent communication cables;
correcting the frequency of at least one of the first and second signals when it is determined that the beat waveform generation condition is satisfied; and
transmitting at least the signal of which the frequency has been corrected.

2. The noise removing method according to claim 1, wherein the computer executes:
determining whether the beat waveform generation condition is satisfied based on the corrected frequency of the signal; and
transmitting the signal of which the frequency has been corrected when it is determined that the beat waveform generation condition is not satisfied based on the corrected frequency of the signal.

3. The noise removing method according to claim 1, wherein
of the received signals, a signal having a higher frequency is the first signal, and
a signal having a lower frequency is the second signal, and the computer executes:
decreasing a frequency F_{i,1} of the first signal and a frequency F_{i,2} of the second signal based on Formula 1; and
determining that the beat waveform generation condition is satisfied when both the decreased frequency F_{i,1} of the first signal and the decreased frequency F_{i,2} of the second signal are equal to or less than each of corresponding predetermined thresholds,
$$\begin{matrix}[ Math . 1 ] & \\ \begin{matrix}{F}_{i , 1} = {F}_{i - 1 , 2} \\ {F}_{i , 2} = {F}_{i - 1 , 1} - {n}_{i} \times {F}_{i - 1 , 2}\end{matrix} & ( 1 )\end{matrix}$$
wherein i in Formula 1 is an integer representing a number of times the frequencies of the first and second signals are decreased,
F_{i,1} represents the frequency of the first signal decreased i times,
F_{i,2} represents the frequency of the second signal decreased i times,
F_{0,2} represents the frequency of the second signal before the frequency is decreased,
F_{0,1} represents a frequency f₁ of the first signal before the frequency is decreased, and
nᵢ is an integer satisfying a condition of Formula 2,
$$\begin{matrix}[ Math . 2 ] & \\ {F}_{i - 1 , 2} > {F}_{i - 1 , 1} - {n}_{i} \times {F}_{i - 1 , 2} ≧ 0 & ( 2 )\end{matrix}$$

4. The noise removing method according to claim 1, wherein, when it is determined that the beat waveform generation condition is satisfied, the computer executes correcting the frequency of at least one of the first and second signals by adding a predetermined frequency to the frequency of at least one of the first and second signals or subtracting the predetermined frequency from the frequency of the at least one signal.

5. The noise removing method according to claim 1, wherein the computer executes transmitting the first and second signals of which the frequencies have been corrected when the frequencies of both the first and second signals are corrected.

6. The noise removing method according to claim 5, wherein the computer executes:
transmitting the first signal of which the frequency has been corrected and the second signal of which the frequency has not been corrected when the frequency of the first signal is corrected; and
transmitting the first signal of which the frequency has not been corrected and the second signal of which the frequency has been corrected when the frequency of the second signal is corrected.

7. A noise removing apparatus comprising:
at least one memory storing instructions; and
at least one processor executing the instructions to:
determine whether a beat waveform generation condition, which is a condition for beat waveform generation by first and second signals, is satisfied based on frequencies of the first and second signals received via adjacent communication cables;
correct the frequency of at least one of the first and second signals when it is determined that the beat waveform generation condition is satisfied; and
transmit at least the signal of which the frequency has been corrected.

8. The noise removing apparatus according to claim 7, wherein the processor executes instructions for:
determining whether the beat waveform generation condition is satisfied based on the corrected frequency of the signal; and
transmitting the signal of which the frequency has been corrected when it is determined that the beat waveform generation condition is not satisfied based on the corrected frequency of the signal.

9. The noise removing apparatus according to claim 7, wherein of the received signals, a signal having a higher frequency is the first signal, and
a signal having a lower frequency is the second signal, and
the processor executes an instruction for:
decreasing a frequency F_{i,1} of the first signal and a frequency F_{i,2} of the second signal based on Formula 1; and
determining that the beat waveform generation condition is satisfied when the decreased frequency F_{i,1} of the first signal is greater than the corresponding predetermined threshold f_{th, 1} and the decreased frequency F_{i,2} of the second signal is equal to or less than the corresponding predetermined threshold f_{th,2,}
$$\begin{matrix}[ Math . 1 ] & \\ \begin{matrix}{F}_{i , 1} = {F}_{i - 1 , 2} \\ {F}_{i , 2} = {F}_{i - 1 , 1} - {n}_{i} \times {F}_{i - 1 , 2}\end{matrix} & ( 1 )\end{matrix}$$
wherein i in Formula 1 is an integer representing a number of times the frequencies of the first and second signals are decreased,
F_{i,1} represents the frequency of the first signal decreased i times,
F_{i,2} represents the frequency of the second signal decreased i times,
F_{0,2} represents the frequency of the second signal before the frequency is decreased,
F_{0,1} represents a frequency f₁ of the first signal before the frequency is decreased, and
nᵢ is an integer satisfying a condition of Formula 2,
$$\begin{matrix}[ Math . 2 ] & \\ {F}_{i - 1 , 2} > {F}_{i - 1 , 1} - {n}_{i} \times {F}_{i - 1 , 2} ≧ 0 & ( 2 )\end{matrix}$$

10. The noise removing apparatus according to claim 7, wherein when it is determined that the beat waveform generation condition is satisfied, the processor executes an instruction for correcting the frequency of at least one of the first and second signals by adding a predetermined frequency to the frequency of at least one of the first and second signals or subtracting the predetermined frequency from the frequency of the at least one signal.

11. The noise removing apparatus according to claim 7, wherein the processor executes an instruction for transmitting the first and second signals of which the frequencies have been corrected when the frequencies of both the first and second signals are corrected.

12. The noise removing apparatus according to claim 11, wherein the processor executes instructions for:
transmitting the first signal of which the frequency has been corrected and the second signal of which the frequency has not been corrected when the frequency of the first signal is corrected; and
transmitting the first signal of which the frequency has not been corrected and the second signal of which the frequency has been corrected when the frequency of the second signal is corrected.

13. A non-transitory recording medium storing a noise removing program causing a computer to execute:
determining whether a beat waveform generation condition, which is a condition for beat waveform generation by first and second signals, is satisfied based on frequencies of the first and second signals received via adjacent communication cables;
correcting the frequency of at least one of the first and second signals when it is determined that the beat waveform generation condition is satisfied; and
transmitting at least the signal of which the frequency has been corrected.

14. The non-transitory recording medium according to claim 13, wherein the noise removing program causes the computer to execute:
determining whether the beat waveform generation condition is satisfied based on the corrected frequency of the signal; and
transmitting the signal of which the frequency has been corrected when it is determined that the beat waveform generation condition is not satisfied based on the corrected frequency of the signal.

15. The non-transitory recording medium according to claim 13, wherein of the received signals, a signal having a higher frequency is the first signal, and
a signal having a lower frequency is set as a second signal, and
the noise removing program causes the computer to execute:
decreasing a frequency F_{i,1} of the first signal and a frequency F_{i,2} of the second signal based on Formula 1; and
determining that the beat waveform generation condition is satisfied when both the decreased frequency F_{i,1} of the first signal and the decreased frequency F_{i,2} of the second signal are equal to or less than each of corresponding predetermined thresholds,
$$\begin{matrix}[ Math . 1 ] & \\ \begin{matrix}{F}_{i , 1} = {F}_{i - 1 , 2} \\ {F}_{i , 2} = {F}_{i - 1 , 1} - {n}_{i} \times {F}_{i - 1 , 2}\end{matrix} & ( 1 )\end{matrix}$$
wherein i in Formula 1 is an integer representing a number of times the frequencies of the first and second signals are decreased,
F_{i,1} represents the frequency of the first signal decreased i times,
F_{i,2} represents the frequency of the second signal decreased i times,
F_{0,2} represents the frequency of the second signal before the frequency is decreased,
F_{0,1} represents a frequency f₁ of the first signal before the frequency is decreased, and
nᵢ is an integer satisfying a condition of Formula 2,
$$\begin{matrix}[ Math . 2 ] & \\ {F}_{i - 1 , 2} > {F}_{i - 1 , 1} - {n}_{i} \times {F}_{i - 1 , 2} ≧ 0 & ( 2 )\end{matrix}$$

16. The non-transitory recording medium according to claim 13, wherein, when it is determined that the beat waveform generation condition is satisfied, the noise removing program causes the computer to execute correcting the frequency of at least one of the first and second signals by adding a predetermined frequency to the frequency of at least one of the first and second signals or subtracting the predetermined frequency from the frequency of the at least one signal.

17. The non-transitory recording medium according to claim 13, wherein the noise removing program causes the computer to execute transmitting the first and second signals of which the frequencies have been corrected when the frequencies of both the first and second signals are corrected.

18. The non-transitory recording medium according to claim 17, wherein the noise removing program causes the computer to execute:
transmitting the first signal of which the frequency has been corrected and the second signal of which the frequency has not been corrected when the frequency of the first signal is corrected; and
transmitting the first signal of which the frequency has not been corrected and the second signal of which the frequency has been corrected when the frequency of the second signal is corrected.
